(19) United States
(12) Patent Application Publication
(10) Pub. No.: US 2002/0070867 A1
(43) Pub. Date: Jun. 13, 2002

(54) Patient movement detection apparatus

(76) Inventors: Kevin P. Conway, Kalamazoo, MI (US); Kenneth L. Kramer, Anaheim Hills, CA (US); Carlos E. Valdes, Alta Loma, CA (US)

Correspondence Address: FLYNN, THIEL, BOUTELL & TANIS, P.C., 2026 Rambling Road, Kalamazoo, MI, 49008-1699, US

(21) Appl. No.: 09/993,329

(22) Filed: Nov. 14, 2001

Related U.S. Application Data
(60) Provisional application No. 60/248,873, filed on Nov. 15, 2000.

(51) Int. Cl. G08B 23/00

(52) U.S. Cl. 340/573.1; 340/666

(57) ABSTRACT

A patient movement detection device is provided comprising a plurality of load cell disks, beams, or columns placed under a support member of a patient support device. The load cells are connected to a processing unit by a plurality of transmission cables. The processing unit is connected to a peripheral communication device. A method of detection of movement of a patient is provided comprising the steps of generating a signal by a load cell disk or beam when a change in a patient's center of gravity occurs on the patient support device, transmitting the signal to a processing unit, and further transmitting the signal to the peripheral communication device.

### BACKGROUND OF THE INVENTION

The present invention relates to an arrangement for detecting patient movement within a patient support device such as a hospital bed, chair, wheel chair or similar support structure and, more particularly, to a load cell center of gravity based arrangement capable of detecting patient movement while a substantial portion of the patient's weight is still supported on the patient support device.

In a health care setting, it is sometimes necessary to monitor a patient in order to help ensure that the patient remains in a patient support device such as a bed, a chair, a wheel chair or the like. For example, a patient who is physically capable of leaving the bed but who is subject to dizziness upon standing up might fall and injure himself if he leaves the bed when no attendant is present. Consequently, it is desirable that an alarm be given in the event the patient leaves the bed so that a member of a health care staff will be alerted to the fact that the patient has left the bed and may help ensure that the patient does not experience an injury.

An early technique for automatically detecting patient exit from support devices such as beds involved the provision of a normally-closed mechanical switch in the mattress or springs of a bed, the weight of the patient being sufficient to open the switch, and the absence of the patient permitting the switch to assume its closed condition. The switch could be connected in a series circuit with a source of power such as a battery and with an alarm such as a buzzer, and would thus produce audible noise when the patient left the bed. Switch based systems were often inaccurate and often presented a false alarm condition where the patient either had not substantially moved within the patient support device or had already substantially left the support device prior to alarming.

Modem patient movement detection systems include a support frame of a patient support device, such as a hospital bed, being supported by a plurality of load cells, and a detecting arrangement responsive to the load cells for detecting a situation in which a patient is leaving the frame. The detecting arrangement determines a location with respect to the support frame of a center of gravity of a patient supported on the frame and determines whether the location of the center of gravity is within a predetermined region. One known system of this type is disclosed in Travis U.S. Pat. No. 5,276,432. While known systems of this type have been adequate for their intended purposes, they have not been satisfactory in all respects.

For example, the load cells and associated transmitting hardware and software are built into the frames of the bed support device, thereby preventing utilization of the exit alarm system on any other device within the health care facility. Such systems can be expensive and are often cost prohibitive for many health care operations. However, because load cell based center of gravity exit determination systems have proven to be more reliable than the early switch methods it is desirable to develop an affordable load cell based system which can be retrofitted onto any patient support surface in any health care facility.

### SUMMARY OF INVENTION

The present invention includes a first embodiment of a patient movement detection apparatus comprising a plurality of load cell discs for placement under a support member of a patient support device such as a leg of a bed, a chair or a wheel chair. The load cell discs are placed in compression through a force applied by the support member of the patient support device. The load cell disks contain a plurality of strain gages for measuring compression and tensile stresses placed on the strain gages during shifting of a patient's center of gravity on the patient support device. A placement and an arrangement of the strain gages within a structure of the load cell disks helps to minimize the effect of a potential off-center or a side load introduced onto the load cell disks by the support member. The structure of the load cell disk is also optimized for hysteresis performance and the minimization of thermal expansion and compression due to temperature.

Connected to the load cell disks is a plurality of transmission cables for transmitting a signal generated by the strain gages to a processing unit. The processing unit is connected by a transmission cable to a peripheral communication device which creates a signal alerting a health care worker to the shift in the patient's center of gravity on the patient support device. Types of peripheral communication devices may include systems such as a nurse call system, a room lighting system, a telephone, a television, a computer, a pager, or another device capable of emitting a visual, audible, or sensory signal. In the current embodiment, the load cell disks, the transmission cables, and the processing unit are all capable of being mounted external of a structure of the patient support device. Alternatively, the load cell disks, the transmission cables, and the processing unit could be affixed to or routed within the structure of the patient support device after or during an initial manufacture of the patient support device.

A second embodiment of the present invention includes a patient movement detection apparatus comprising a plurality of load cell beams attached to an end of a support member of a patient support device such as a leg of a bed or a chair. When attached, a portion of the support member of the patient support device is supported within an end of the load cell beam. Under load, the portion of the support member device supported by the load cell beam applies a shear load to the load cell beam between the end of the load cell beam supporting the support member of the patient support device and an end of the load cell beam that does not support the portion of the support member. The load cell beams include a plurality of strain gages for measuring compression and tensile stresses placed on the strain gages by, the shear load established during shifting of a patient's center of gravity on the patient support device. Connected to the load cell beams is a plurality of transmission cables for transmitting a signal generated by the strain gages to a processing unit. The processing unit is connected by a transmission cable to a peripheral communication device which creates a signal alerting a health care worker to the shift in the patient's center of gravity on the patient support device. Types of peripheral communication devices may include systems such as a nurse call system, a room lighting system, a telephone, a television, a computer, a pager, or another device capable of emitting a visual, audible, or sensory signal. In the present embodiment, the load cell beams, the transmission cables, and the processing unit are all capable of being mounted external of a structure of the patient support device. Alternatively, the load cell beams, the transmission cables, and the processing unit could be affixed to or routed within the structure of the patient support device after or during an initial manufacture of the patient support device.

A third embodiment of the present invention includes a patient movement detection apparatus comprising a plurality of load cell columns attached as support legs to a patient support device such as a bed or a chair. When attached, the patient support device is supported by the load cell columns. Under load, a compression load is applied to the load cell column. The load cell columns include a plurality of strain gages for measuring compression and tensile stresses placed on the strain gages by the compression load established during shifting of a patient's center of gravity on the patient support device. Connected to the load cell columns is a plurality of transmission cables for transmitting a signal generated by the strain gages to a processing unit. The processing unit is connected by a transmission cable to a peripheral communication device which creates a signal alerting a health care worker to the shift in the patient's center of gravity on the patient support device. Types of peripheral communication devices may include systems such as a nurse call system, a room lighting system, a telephone, a television, a computer, a pager, or another device capable of emitting a visual, audible, or sensory signal. In the present embodiment, the load cell beams, the transmission cables, and the processing unit are all capable of being mounted external of a structure of the patient support device. Alternatively, the load cell columns, the transmission cables, and the processing unit could be affixed to or routed within the structure of the patient support device after or during an initial manufacture of the patient support device.

### BRIEF DESCRIPTION OF THE DRAWINGS

FIG. 1A is a perspective view of a patient support device with a load cell disk patient movement detection apparatus according to the invention;

FIG. 1B is a perspective view of a disk load cell of the invention;

FIG. 2A is a perspective side view of the disk load cell with a transmission cable attached;

FIG. 2B is a top view of the disk load cell;

FIG. 3A is a perspective view of a patient support device with a load cell beam patient movement detection apparatus according the invention;

FIG. 3B is an assembly view of a load cell beam of the invention;

FIG. 4A is a perspective side view of the load cell beam; and

FIG. 4B is a perspective bottom view of the load cell beam; and

FIG. 5A is a perspective view of a bed patient support device with a load cell beam mounted to a frame member of the bed; and

FIG. 5B is a perspective view of a load cell beam mounted to a head end of a frame member of a patient support device; and

FIG. 5C is a perspective view of a load cell beam mounted to a foot end of a frame member of a patient support device; and

FIG. 6A is a perspective front view of a load cell column with a mounting bracket attached according to the present invention; and

FIG. 6B is a perspective side view of a load cell column with a transmission cable attached.

### DETAILED DESCRIPTION OF A PREFERRED EMBODIMENT

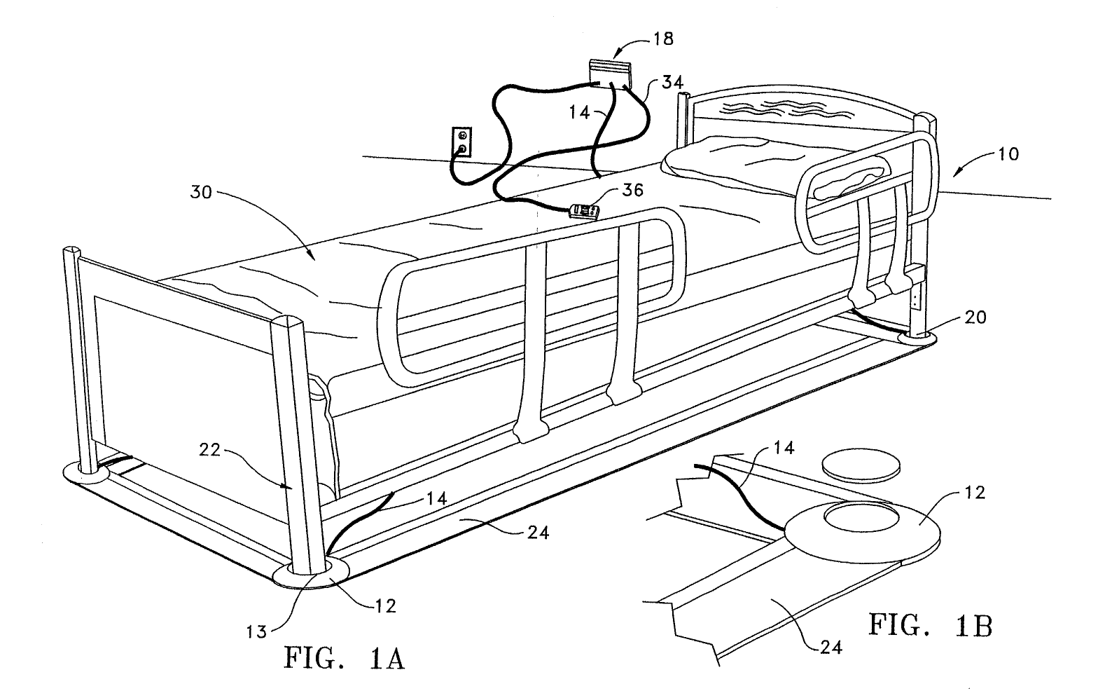

Referring to the Figures wherein like numerals indicate like or corresponding parts throughout the several views, in FIG. 1A a load cell disk patient movement detection apparatus of a first embodiment is shown generally at 10. The apparatus 10 is shown attached to a patient support device 30 comprised of a plurality of support members 20 and a plurality of structural members 22. The patient support device 30 shown in FIG. 1A is a bed. Alternatively, the patient support device 30 could be a chair or a wheel chair or any patient support device that supports a body of a patient in a health care setting. The apparatus 10 comprises a plurality of load cell disks 12 placed under the support members 20 of the patient support device 30. The patient support members 20 apply a compressive load to a top portion 13 of the load cell disks 12. A plurality of transmission cables 14 are attached to the load cell disks 12 for transmitting a signal generated by the load cell disks 12 to a combination processing unit/peripheral communication device 18. Alternatively, (not shown) the combination processing unit/peripheral communication unit 18 may be two separate units comprising a processing unit connected by a transmission cable to a peripheral communication device. The combination processing unit/peripheral communication device 18 shown in FIG. 1A is a nurse call system with a nurse call pendant 36 connected to the combination processing unit/peripheral communication device 18 by a transmission cable 34. Alternatively, (not shown) the communication device could comprise a room lighting system, a telephone, a television, a computer, a pager, or another device capable of emitting a visual, audible, or sensory signal. In FIG. 1A the apparatus 10 comprised of the load cell disks 12, the transmission cables 14, and the combination processing unit/peripheral communication device 18 are shown external to the support members 20 such that the apparatus 10 could be retrofitted onto any patient support device 30 after an initial manufacture of the patient support device 30. Alternatively, the apparatus 10 could be integrated within the support members 20 of the patient support device 30 at the time of manufacture.

In FIG. 1B the load cell disk 12 is shown in closer detail. The load cell disk 12 has a circular shape and is large enough to support the support member 20 without extending beyond a perimeter 24 of the patient support device 30 (shown in FIG. 1A).

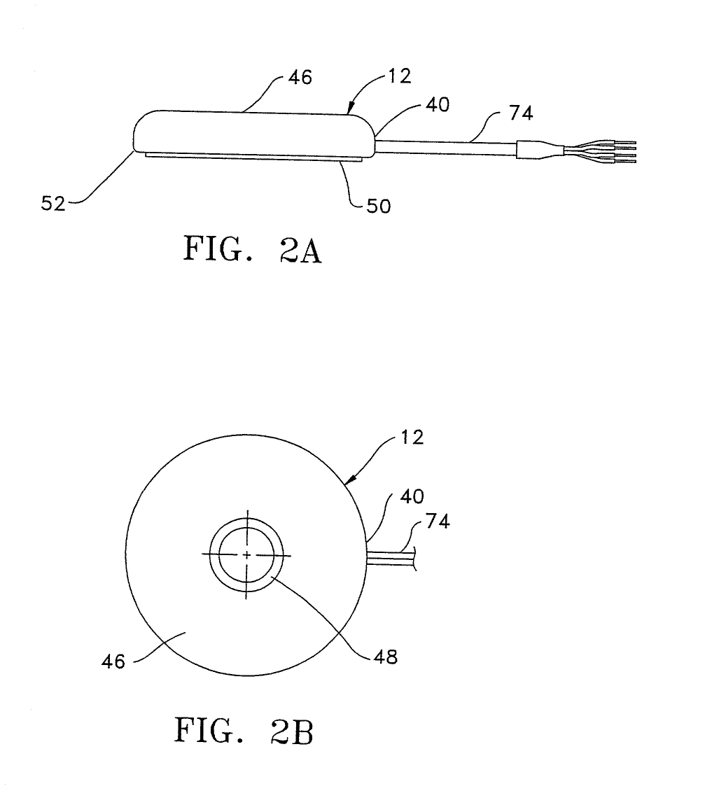

In FIG. 2A a top view of the load cell disk 12 is shown with a transmission cable 74 exiting a side 40 of the load cell disk 12. The load cell disk. 12 is constructed out of a solid material such as an aluminum alloy. The load cell disk 12 contains a recess 48 in a top surface 46 where a load received from the support member 20 is centered on the load cell disk 12. Internally (not shown) within the load cell disk 12 is abeam having an end adjacent the recess 48 in the top surface 46 for receiving the load transmitted through the recess 48 by the support member 20. The load cell disk 12 contains a plurality of axial strain gages (not shown) mounted on a bottom of the beam. The strain gages measure the tensile and compression stresses present in the beam under load and transmit a signal through transmission cable 74.

In FIG. 2B a side view of the load cell disk 12 is shown with a transmission cable 74 exiting a side 40 of the load cell disk 12. A pad 50 is mounted to a bottom side 52 of the load cell disk 12 providing a non-skid surface. The pad 50 is constructed of a plate (not shown) with a neoprene, or any other soft low friction material, bonded to the plate providing the non-skid surface.

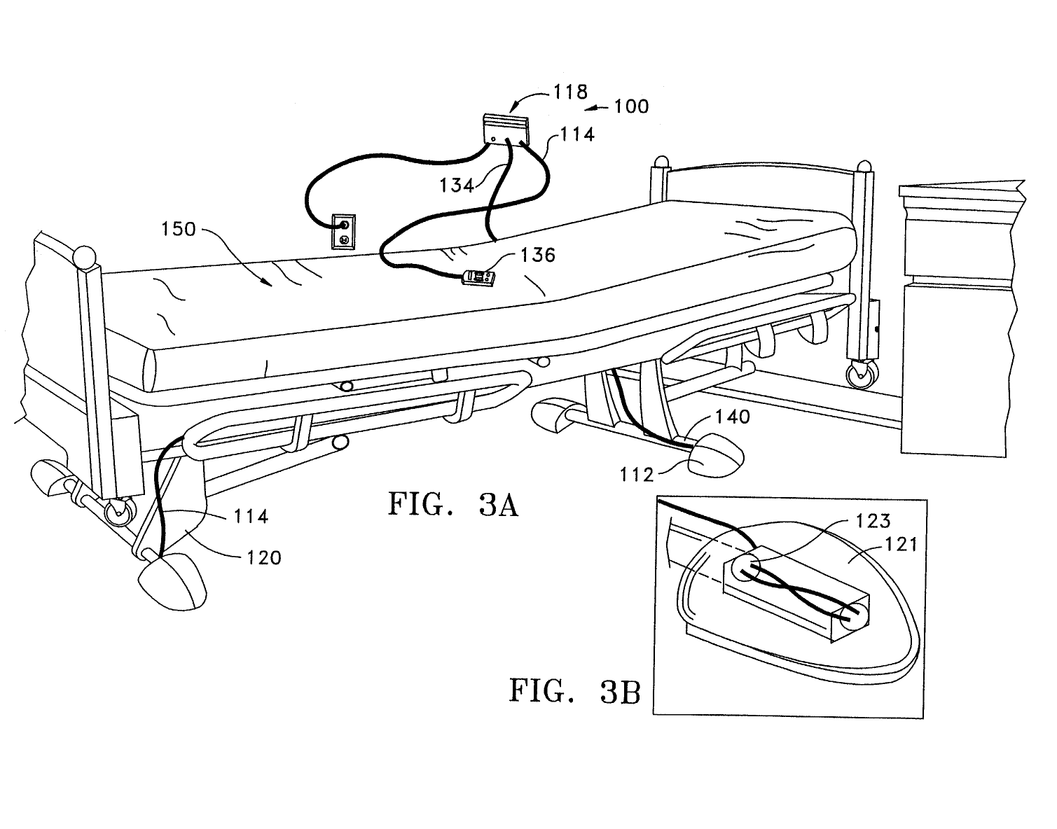

In FIG. 3A a load cell beam patient movement detection apparatus of a second embodiment is shown generally at 100. The apparatus 100 is shown attached to a patient support device 150 comprised of a plurality of support members 120 and a plurality of structural members 122. The patient support device 150 shown in FIG. 3A is a bed. Alternatively, the patient support device 150 could be a chair or a wheel chair or any patient support device that supports a body of a patient in a health care setting. The apparatus 100 comprises a plurality of load cell beams 112 placed partially under an end 140 of the support members 120 of the patient support device 150. The patient support members 120 apply a shear load to the load cell beams 112. A plurality of transmission cables 114 are attached to the load cell beams 112 for transmitting a signal generated by the load cell beams 112 to a combination processing unit/peripheral communication device 118. Alternatively, (not shown) the combination processing unit/peripheral communication unit 118 may be two separate units comprising a processing unit connected by a transmission cable to a peripheral communication device. The combination processing unit/peripheral communication device 118 shown in FIG. 3A is a nurse call system with a nurse call pendant 136 connected to the combination processing unit/peripheral communication device 118 by a transmission cable 134. Alternatively, (not shown) the communication device could comprise a room lighting system, a telephone, a television, a computer, a pager, or another device capable of emitting a visual, audible, or sensory signal. In FIG. 3A the apparatus 100 comprised of the load cell beams 112, the transmission cables 114, and the combination processing unit/peripheral communication device 118 are shown external to the support members 120 such that the apparatus 100 could be retrofitted onto any patient support device 150 after an initial manufacture of the patient support device 150. Alternatively, the apparatus 100 could be integrated within the support members 120 of the patient support device 150 at the time of manufacture.

In FIG. 3B the load cell beam 112 is shown with a cover 121 in phantom lines. The load cell beam 112 is a cylindrical shaped bar and is large enough to support a portion 123 of the support members 120.

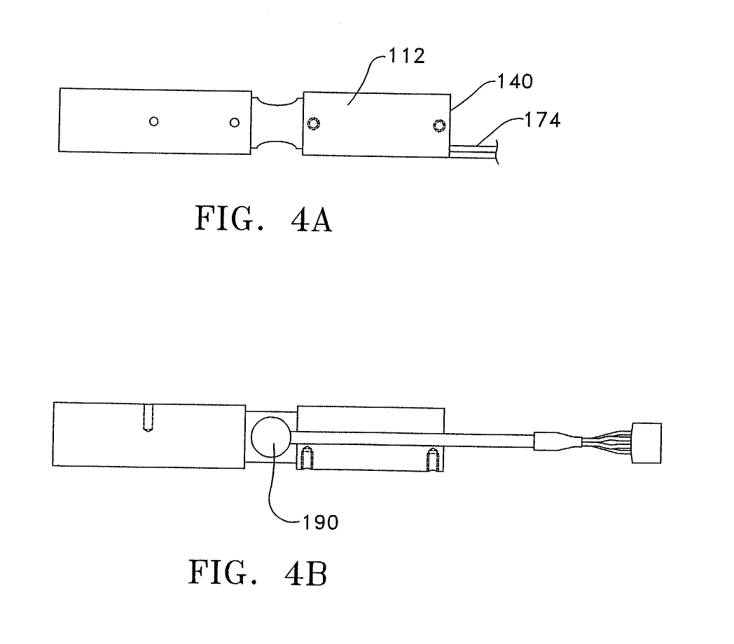

In FIG. 4A a side view of the load cell beam 112 is shown with a transmission cable 174 exiting a end 140 of the load cell beam 112. The load cell beam 112 is constructed out of a solid material such as an aluminum alloy. Internally (not shown) the load cell beams 112 include a plurality of shear strain gages for measuring the shear load established during shifting of a patient's center of gravity on the patient support device. The strain gages measure the shift in shear load and transmit a signal to the transmission cable 174.

In FIG. 4B a bottom view of the load cell beam 112 is shown with a transmission cable 174 exiting the end 140 of the load cell beam 112. The load cell beam 112 is shown with a hole 190 that is used to create the shear load on the strain gages (not shown).

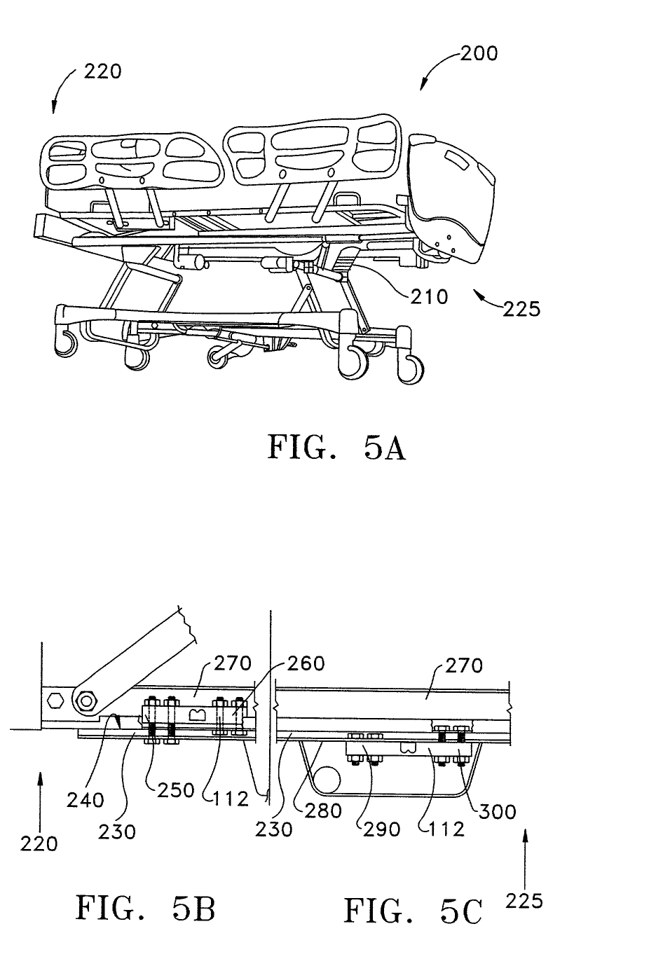

In FIG. 5A a bed patient support device with a load cell beam 112 (not shown) mounted on the support members 120 is shown generally at 200. The load cell beam 112 is mounted behind a plurality of covers 210 at a head end 220 and a foot end 225 of the bed patient support device 200.

In FIG. 5B a load cell beam 112 is shown mounted at the head end 220 of the bed patient support device 200 (as shown in FIG. 5A). The load cell beam 112 is mounted to a top side 240 of the support member 230 at an end 250 and is mounted at another end 260 to the underside of support member 270. A flex under load between support members 270 and 230 provide a bending moment within the load cell beam 112.

In FIG. 5C a load cell beam 112 is shown mounted to the foot end 225 of the bed patient support device 200 (as shown in FIG. 5A). The load cell beam 112 is mounted to an underside 280 of a support member 230 at an end 290 and is mounted through support members 270 and 230 at an end 300. A flex under load between support members 230 and 270 provide a bending moment within load cell beam 112.

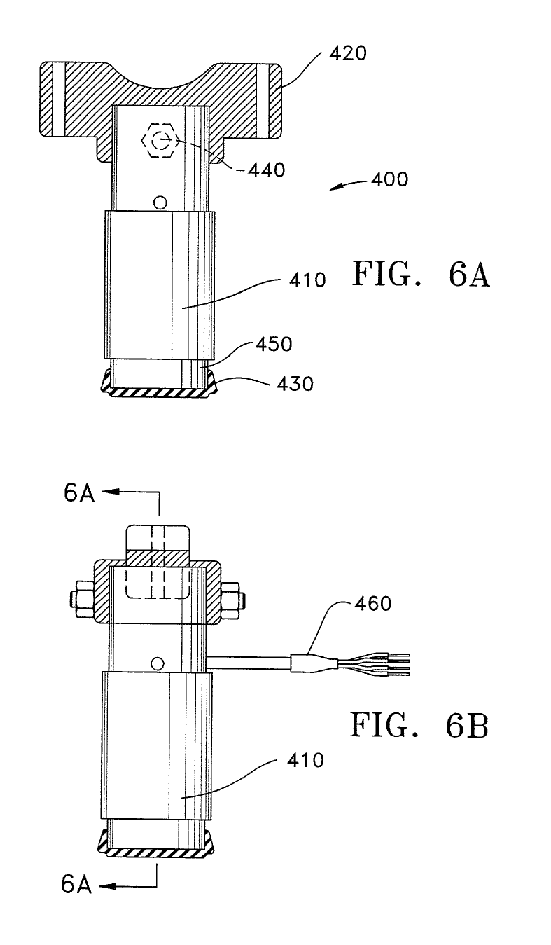

In FIG. 6A a load cell column patient movement detection apparatus of a third embodiment is shown generally at 400. The load cell column patient movement detection apparatus 400 comprises a plurality of load cell columns 410 mounted to a patient support device (not shown) by a mounting bracket 420. The load cell columns 410 are attached to the mounting bracket 420 by a fastener 440. When in place, the load cell columns 410 serve as a leg of a patient support device providing partial support of the patient support device. The load cell columns 410 comprise a plurality of strain gages (not shown) for reacting to the compression and tension forces applied to the load cell columns 410 by the patient support device. Attached to a bottom 450 of the load cell columns 410 is a rubber or synthetic cap providing a soft base for the load cell columns 410.

In FIG. 6B a load cell column 410 is shown with a transmission cable 460 attached for transmitting a signal generated by the load cell column 410 to a processing unit (not shown).

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

We claim:

1. A patient movement detection apparatus comprising:
a plurality of load cell disks mounted under a plurality of support members of a patient support device;
said load cell disks comprising a plurality of strain gages for measuring a compression load applied to said load cell disks by said support members;
said load changing as a result in a shift in a center of gravity of a patient supported on said patient support device;
a plurality of transmission cables connected to said load cell disks;
a processing unit connected to said transmission cables; and
a peripheral communication device connected to said processing unit.

2. A patient movement detection apparatus comprising:
a plurality of load cell beams mounted partially under a plurality of support members of a patient support device;
said load cell beams comprising a plurality of strain gages for measuring a shear load applied to said load cell beams by said support members;
said load changing as a result in a shift in a center of gravity of a patient supported on said patient support device;
a plurality of transmission cables connected to said load cell disks for transmitting a signal generated by said load cell disks;
a processing unit connected to said transmission cables for processing said signal; and
a peripheral communication device connected to said processing unit for communicating a processed signal.

3. A method of detecting patient movement in a patient support device comprising the steps of:
a.) generating a signal by a plurality of load cell disks placed under a patient support member of a patient support device;
b.) transmitting said signal to a processing unit by a plurality of transmission cables;
c.) processing said signal by said processing unit and transmitting a processed signal to a peripheral communication device; and
d.) communicating said processed signal by said communication device.

4. A method of detecting patient movement in a patient support device comprising the steps of:
a.) generating a signal by a plurality of load cell beams placed under a patient support member of a patient support device;
b.) transmitting said signal to a processing unit by a plurality of transmission cables;
c.) processing said signal by said processing unit and transmitting a processed signal to a peripheral communication device; and
d.) communicating said processed signal by said communication device.
